(19) United States
(12) Patent Application Publication
(10) Pub. No.: US 2007/0241540 A1
(43) Pub. Date: Oct. 18, 2007

(54) Structure for protecting a passenger

(75) Inventors: Naoki Takemura, Saitama-shi (JP); Koji Ikeda, Kawachi-gun (JP); Hiroyuki Isayama, Kawachi-gun (JP)

Correspondence Address: CARRIER BLACKMAN AND ASSOCIATES, 24101 NOVI ROAD, SUITE 100, NOVI, MI, 48375, US

(73) Assignee: Honda Motor Co., Ltd., Tokyo (JP)

(21) Appl. No.: 11/725,683

(22) Filed: Mar. 20, 2007

(30) Foreign Application Priority Data
Apr. 13, 2006 (JP) 2006-110832

(51) Int. Cl. B60R 21/217; B60R 21/213

(52) U.S. Cl. 280/728.2; 280/730.2

(57) ABSTRACT

A structure for protecting a passenger of a vehicle includes a vehicle body of the vehicle; an interior material arranged on an inner side of the vehicle body, which faces an interior of the vehicle; an airbag which is stored between the vehicle body and the interior material, and is deployed toward the interior; and an attachment device for attaching the interior material to the vehicle body in a manner such that the interior material is movable to a distant position at which the airbag is deployable. The structure also has a forcing device, provided to the interior material, for forcing the interior material toward the vehicle body, or a returning device, provided to the interior material, for returning the interior material toward the vehicle body. The forcing device may be an elastic body coupled with the interior material and the vehicle body.

### BACKGROUND OF THE INVENTION

1. Field of the Invention

The present invention relates to a structure for protecting a passenger, in which an airbag stored between a vehicle body and an interior material in a vehicle is deployed toward the interior of the vehicle.

Priority is claimed on Japanese Patent Application No. 2006-110832, filed Apr. 13, 2006, the content of which is incorporated herein by reference.

2. Description of the Related Art

In an example of a structure for protecting a passenger, in which an airbag stored between a vehicle body and an interior material in a vehicle is deployed toward the interior of the vehicle, the airbag is deployed along an inner side (toward the interior of the vehicle) of a side window of the vehicle in a form such as that of a drawn curtain, when a side collision of the vehicle occurs. In such a structure, the airbag is deployed while a part of the interior material for covering the inside of the interior is pushed away toward the interior of the vehicle; thus, the relevant interior material is attached to the vehicle body in a manner such that it is movable to a position at which the airbag can be deployed (see, for example, Japanese Unexamined Patent Application, First Publication No. H11-115672).

In such a structure in which the interior material is moved away from the vehicle body when the airbag is deployed, an impact absorbing performance of the interior material itself, which can be obtained when the interior material is positioned in the vicinity of the vehicle body, may be insufficient.

### SUMMARY OF THE INVENTION

In light of the above circumstances, an object of the present invention is to provide a structure for protecting a passenger, so as to provide a sufficient impact absorbing performance of the interior material itself even after the airbag is deployed.

Therefore, the present invention provides a structure for protecting a passenger of a vehicle, comprising:

a vehicle body (e.g., a pillar inner panel 25 in embodiments explained later) of the vehicle;

an interior material (e.g., a pillar garnish 27 in the embodiments) arranged on an inner side of the vehicle body, which faces an interior of the vehicle;

an airbag (e.g., an airbag 20 in the embodiments) which is stored between the vehicle body and the interior material, and is deployed toward the interior;

an attachment device (e.g., clips 40, 64, 70, and 100 in the embodiments) for attaching the interior material to the vehicle body in a manner such that the interior material is movable to a distant position at which the airbag is deployable; and

a forcing device (e.g., springs 41, 66, and 10, and a clip 70 in the embodiments), provided to the interior material, for forcing the interior material toward the vehicle body.

In accordance with the above structure, when the airbag, which is stored between the vehicle body and the interior material (which is arranged on an inner side of the vehicle body, which faces an interior of the vehicle) is deployed toward the interior of the vehicle, the interior material is moved by the attachment device towards a position distant from the vehicle body, so that the airbag can be expanded. After the airbag is deployed, the interior material is forced by the forcing device (provided to the interior material) toward the vehicle body so that the interior material returns toward the vehicle body. That is, after the airbag is deployed, the interior material approaches the vehicle body; thus, the interior material restores the impact absorbing ability which it obtains originally.

In a first typical example, the forcing device is an elastic body (e.g., the springs 41 and 110 in the embodiments) coupled with the interior material and the vehicle body.

Accordingly, the interior material is coupled with the vehicle body via the elastic body as the forcing device, so that the elastic body prevents the interior material from being detached.

In this case, it is possible that:

the attachment device is a clip (e.g., the clip 40 in the embodiments) having a head part (e.g., a head part 50 in the embodiments) and a shaft part (e.g., a first shaft part 51, a second shaft part 52, and a shaft part 53 in the embodiments) extending from the head part; and

the head part is attached to the interior material; and

the shaft part passes through an attachment hole (e.g., an attachment hole 35 in the embodiments) formed in the vehicle body in a manner such that the shaft part is slidable along an axial direction thereof.

Accordingly, when the interior material returns toward the vehicle body (after it moves away from the vehicle body), the shaft par of the clip (which is fastened to the interior material via the head part of the clip) slides axially along the attachment hole which is formed at the vehicle body. Therefore, it is possible to prevent the interior material from moving in a direction other than the predetermined direction.

It is also possible that the attachment device is a clip (e.g., the clip 100 in the embodiments) having:

a head part (e.g., a head part 105 in the embodiments) attached to the interior material;

an end part (e.g., an end part 101 in the embodiments) which is attached to the vehicle body and is separably coupled via the elastic body with the interior material; and

a shaft part (e.g., a shaft part 106 in the embodiments) extending from one of the head part and the end part toward the other of the head part and the end part.

Accordingly, the clip has the shaft part extending from one of the head part (attached to the interior material) and the end part (separably coupled via the elastic body with the interior material) toward the other of them; thus, the end part can be pushed by the shaft part so that the end part is attached to the vehicle body. Therefore, it is possible to easily attach the clip to the vehicle body, wherein the clip as the attachment device is attached to the interior material in advance.

In a second typical example, the forcing device is an elastic body (e.g., the spring 66 in the embodiments) provided between the interior material and the attachment device. Accordingly, it is unnecessary to move the attachment device with respect to the vehicle body. Accordingly, sliding of the interior material can be guided using the interior material itself and the attachment device, which have a relatively high degree of freedom of movement.

In this case, it is possible that:

the attachment device is a clip (e.g., the clip 64 in the embodiments) having a head part (e.g., a head part 60 in the embodiments) and a shaft part (e.g., a first shaft part 61 and a second shaft part 62 in the embodiments) extending from the head part;

the shaft part is attached to the vehicle body;

the head part is fit into a recessed part (e.g., a recessed part 55 in the embodiments) formed in the interior material;

the interior material is slidable along an axial direction of the shaft part while the recessed part is guided by the head part; and

the elastic body is provided in the recessed part.

Accordingly, in the clip, the head part is fit into the recessed part formed in the interior material, and the interior material can slide by the predetermined distance along the axial direction of the head part, which guides the recessed part. Therefore, the clip can guide the movement of the interior material. In addition, the elastic body is provided in the recessed part. Therefore, after the clip and the elastic body is attached to the interior material in advance, the shaft part can be fastened to the vehicle body. Accordingly, the clip and the elastic body can be easily installed at a time.

In the first typical example, it is possible that the elastic body is a clip (e.g., the clip 70 in the embodiments) having:

a rotation member (e.g., a rotation member 72 in the embodiments) attached to the interior material;

a base part (e.g., a base member 75 in the embodiments) attached to the vehicle body; and

an elastic part for coupling the rotation member and the base part with each other via a rotating shaft (e.g., a rotating shaft 73 in the embodiments) in a rotatable manner, and forcing the rotation member and the base part so that they approach each other.

Accordingly, the clip, as the elastic body which forms the forcing device, has the elastic part for coupling the rotation member (attached to the interior material) and the base part (attached to the vehicle body) with each other via the rotating shaft in a rotatable manner, and forcing the rotation member and the base part so that they approach each other; thus, the clip also functions as the attachment device for movably attaching the interior material to the vehicle body. Therefore, the forcing device and the attachment device can be implemented by the single clip.

The present invention also provides a structure for protecting a passenger of a vehicle, comprising:

a vehicle body (e.g., the pillar inner panel 25 in the embodiment) of the vehicle;

an interior material (e.g., the pillar garnish 27 in the embodiments) arranged on an inner side of the vehicle body, which faces an interior of the vehicle;

an airbag (e.g., the airbag 20 in the embodiments) which is stored between the vehicle body and the interior material, and is deployed toward the interior;

an attachment device (e.g., the clip 64 in the embodiments) for attaching the interior material to the vehicle body in a manner such that the interior material is movable to a distant position at which the airbag is deployable; and

a returning device (e.g., a highly-repulsive member 82, and magnetic bodies 85, 86, and 87 in the embodiments), provided to the interior material, for returning the interior material toward the vehicle body.

In this structure, when the airbag, which is stored between the vehicle body and the interior material (which is arranged on an inner side of the vehicle body, which faces an interior of the vehicle) is deployed toward the interior of the vehicle, the interior material is moved by the attachment device towards a position distant from the vehicle body, so that the airbag can be expanded. After the airbag is deployed, the interior material is returned by the returning device (provided to the interior material) toward the vehicle body so that the interior material returns toward the vehicle body. That is, after the airbag is deployed, the interior material approaches the vehicle body; thus, the interior material restores the impact absorbing ability which it obtains originally. Such an effect can be obtained by a simple structure which simply employs the returning device for returning the interior material toward the vehicle body.

In a preferable example, the attachment device is a clip (e.g., the clip 64 in the embodiments) having a head part (e.g., a head part 60 in the embodiments) and a shaft part (e.g., a first shaft part 61 and a second shaft part 62 in the embodiments) extending from the head part;

the shaft part is attached to the vehicle body;

the head part is fit into a recessed part (e.g., a recessed part 55 in the embodiments) formed in the interior material;

the interior material is slidable along an axial direction of the shaft part by a predetermined distance while the recessed part is guided by the head part; and

the returning device is a highly-repulsive part (e.g., the highly-repulsive member 82 in the embodiments) which has a relatively highly repulsive performance and is provided on a bottom face (e.g., a bottom face 55a in the embodiments) in the recessed part, wherein the bottom face is closer to the vehicle body in comparison with other inner faces of the recessed part.

Accordingly, in the clip, the head part is fit into the recessed part formed in the interior material, and the interior material can slide by the predetermined distance along the axial direction of the head part, which guides the recessed part. Therefore, the clip can guide the movement of the interior material. In addition, the returning device is the highly-repulsive part provided on a bottom face in the recessed part; thus, the interior material can be returned toward the vehicle body by using the force due to the movement of the interior material to the distant position. Therefore, the structure for protecting a passenger can be implemented using a further simple structure.

Preferably, a cushioning device (e.g., a cushioning member 83 in the embodiments) is provided on an inner face (e.g., an inner face 55b in the embodiments) of the recessed part, which faces the bottom face.

Accordingly, when the interior material returns to the vehicle body, it is possible to prevent the interior material from moving toward the distant position again, and to reliably return the interior material toward the vehicle body.

In another preferable example, the attachment device is a clip (e.g., the clip 64 in the embodiments) having a head part (e.g., the head part 60 in the embodiments) and a shaft part (e.g., the first shaft part 61 and the second shaft part 62 in the embodiments) extending from the head part;

the shaft part is attached to the vehicle body;

the head part is fit into a recessed part (e.g., the recessed part 55 in the embodiments) formed in the interior material;

the interior material is slidable along an axial direction of the shaft part by a predetermined distance while the recessed part is guided by the head part; and

the returning device is a magnetic body (e.g., the magnetic bodies 85 and 86 in the embodiments) provided on an inner face (e.g., the bottom face 55a and the inner face 55b in the embodiments) of the recessed part and another magnetic body (e.g., the magnetic body 87 in the embodiments) provided at the head part.

Accordingly, in the clip, the head part is fit into the recessed part formed in the interior material, and the interior material can slide by the predetermined distance along the axial direction of the head part, which guides the recessed part. Therefore, the clip can guide the movement of the interior material. In addition, the interior material is returned toward the vehicle body by using at least one of an attractive force and a repulsive force between the magnetic body provided on the inner face of the recessed part and the magnetic body provided at the head part. Therefore, the interior material can be reliably returned toward the vehicle body with a simple structure.

### BRIEF DESCRIPTION OF THE DRAWINGS

FIG. 1 is a partial perspective view showing the interior of a vehicle to which a first embodiment in accordance with the present invention is applied.

FIG. 2 is a sectional view showing the first embodiment.

FIG. 3 is a sectional view showing a variation of the first embodiment.

FIG. 4 is a sectional view showing a second embodiment in accordance with the present invention.

FIG. 5 is a sectional view showing a variation of the second embodiment.

FIG. 6 is a sectional view showing another variation of the second embodiment.

FIG. 7 is a sectional view showing a third embodiment in accordance with the present invention.

FIG. 8 is a sectional view showing a fourth embodiment in accordance with the present invention.

FIG. 9 is a sectional view showing a fifth embodiment in accordance with the present invention.

FIGS. 10A and 10B are perspective views showing a clip used in the fifth embodiment, wherein FIG. 10A shows the clip in its closed state, and FIG. 10B shows the clip in its open state.

FIG. 11 is a sectional view showing a sixth embodiment in accordance with the present invention.

FIG. 12 is a sectional view showing a seventh embodiment in accordance with the present invention.

### DETAILED DESCRIPTION OF THE INVENTION

Hereinafter, embodiments in accordance with the present invention will be described with reference to the appended figures.

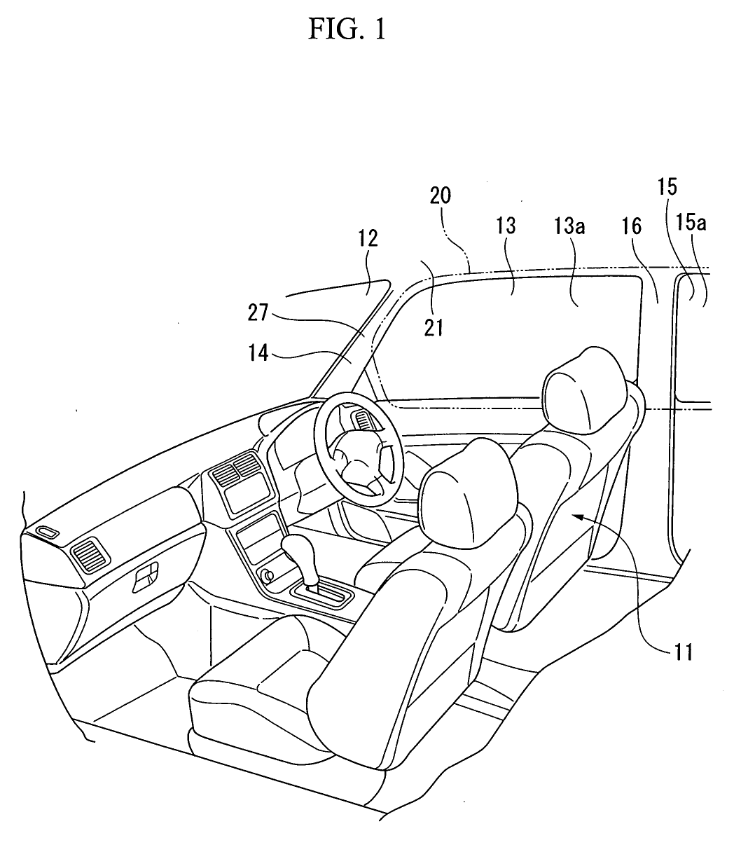

A first embodiment will be explained with reference to FIGS. 1 to 3.

FIG. 1 is a perspective view showing a right-front part in the interior of a vehicle to which the first embodiment is applied.

As shown in FIG. 1, a front pillar 14 is provided between a front window shield 12 and a front door 13, and a center pillar 16 is provided between the front door 13 and a rear door 15. In addition, as shown by an alternate long and two short dashed line in FIG. 1, an airbag 20 is provided, which can be deployed in a form such as that of a drawn curtain, along a window 13a of the front door 13 and a window 15a of the rear door 15.

Before deployment, the airbag 20 is stored in a folded form, along a side edge of a roof 21, staring from the front pillar 14. A similar airbag 20 (not shown) is also provided on the left side in the interior of the vehicle.

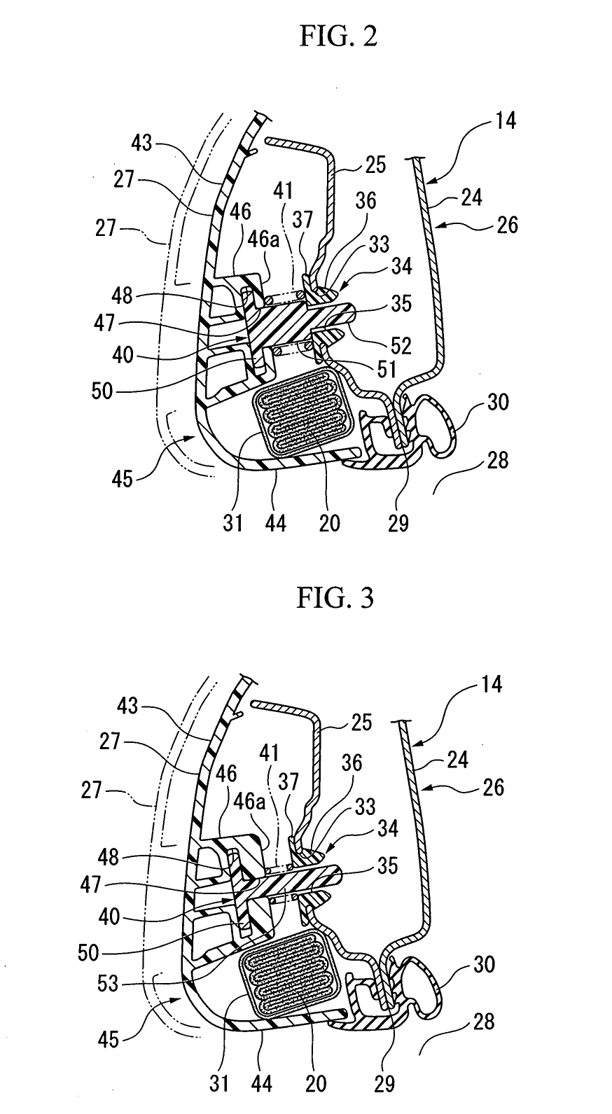

FIG. 2 is a partial sectional view of the front pillar 14. The front pillar 14 has a front pillar main body 26 which forms a part of the vehicle body, and includes: (i) a pillar outer panel 24 which is made of metal, and arranged on the outside of the interior of the vehicle, and (ii) a pillar inner panel 25 which is also made of metal, and joined on the inner side (toward the interior of the vehicle) of the pillar outer panel 24. The front pillar 14 also has a pillar garnish 27 (i.e., an interior material) which is made of synthetic resin, and arranged on the inner side (toward the interior of the vehicle) of the front pillar main body 26 so as to cover the pillar inner panel 25.

Reference numeral 28 indicates a front door opening which is closed or opened by the front door 13, and reference numeral 29 indicates a joint end of the pillar outer panel 24 and the pillar inner panel 25, which faces the front door opening 28. A weather strip 30 made of rubber is provided to the joint end 28 so as to seal a gap between the front pillar 14 and the front door 13 which is opened or closed.

In addition, the airbag 20, which is deployable toward the inside of the interior of the vehicle, is stored in a folded form between the pillar inner panel 25 and the pillar garnish 27, where a cover 31 is provided to the airbag 20.

The pillar inner panel 25 has a through-hole 33 which is open along the inner-to-outer direction with respect to the interior of the vehicle. An attachment member 34 made of synthetic resin is attached to the through-hole 33, where the attachment member 34 functions as a part of the vehicle body. An attachment hole 35 is formed at the center of the attachment member 34. On the outer-peripheral side of the attachment member 34, a fittable part 36 and a flange portion 37 are respectively provided on the outer side (toward the outside of the vehicle) and the inner side (toward the interior of the vehicle) thereof. The fittable part 36 has a tapered shape and is fit into the through-hole 33 of the pillar inner panel 25. When the fittable part 36 is fit into the through-hole 33, the pillar inner panel 25 is supported between the fittable part 36 and the flange portion 37.

The pillar garnish 27 is attached to the pillar inner panel 25 via a clip 40 (i.e., an attachment device) made of synthetic resin. Between the pillar garnish 27 and the attachment member 34 (which belongs to the vehicle body), a spring 41 (i.e., a forcing device) having a coil form is provided, through which the clip 40 passes.

The pillar garnish 27 has a design plate part 45 which includes a main plate part 43 and an end plate part 44 which extends from an end (toward the front door opening 28) of the main plate part 43. The design plate part 45 functions as a design surface in the interior of the vehicle. The pillar garnish 27 also has a protruding stand part 46 which protrudes toward the outside of the interior from the back face of the main plate part 43 in the design plate part 45. In the protruding stand part 46, an attachment hole 47 is open from a top face 46a of the protruding form, and a fittable groove 48, extending in the radial directions, is formed on a side (toward the main plate part 43) of the attachment hole 47.

The clip 40 is attached to the protruding stand part 46 of the pillar garnish 27, and extends toward the outside of the interior from the protruding stand part 46. More specifically, the clip 40 has: (i) a head part 50 which has a relatively large diameter and is fit into the fittable groove 48 of the protruding stand part 46 so as to attach the clip 40 to the pillar garnish 27, (ii) a first shaft part 51 (functioning as the shaft part of the present invention) which has a smaller diameter than that of the head part 50 and extends in the axial direction thereof from the head part 50 through the attachment hole 47 of the protruding stand part 46 toward the outside of the interior, and (iii) a second shaft part 52 (also functioning as the shaft part of the present invention) which has a smaller diameter than that of the first shaft part 51 and extends from the first shaft part 51 toward a side opposite to the head part 50. Although it is not shown, the fittable groove 48 is open toward a side thereof, so that the clip 40 can be slid and fit into the groove 48 in a direction perpendicular to the axis of the shaft of the clip 40. In addition, the clip 40 is contained in a manner such that the second shaft part 52 is slidable through the attachment hole 35 of the attachment member 34.

Most of the first shaft part 51 passes through the spring 41. In this state, an end of the spring 41 is coupled to the protruding stand part 46 of the pillar garnish 27, and the other end thereof is coupled to the flange portion 37 of the attachment member 34, so that the pillar garnish 27 and the attachment member 34 which belongs to the vehicle body are coupled with each other. The spring 41 forces the pillar garnish 27 toward the pillar inner panel 25 so that an end face of the first shaft part 51 of the clip 40 contacts the attachment member 34. The spring 41 is uniformly arranged around the first shaft part 51 in a manner such that a small gap is provided between the spring 41 and the clip 40.

When the airbag 20, which is contained in a folded form in the cover 31, is fastened to the vehicle body, the airbag 20 along the front pillar main body 26 is closer to the front door opening 28 in comparison with the through-hole 33 of the pillar inner panel 25. The pillar garnish 27, to which the above-described clip 40, spring 41, and attachment member 34 are attached in advance, is attached to the pillar inner panel 25 by fitting the attachment member 34 into the through-hole 33 while containing the folded airbag 20 between the protruding stand part 46 and the end plate part 44. Owing to the clip 40 fastened to the pillar garnish 27, the pillar garnish 27 is attached to the pillar inner panel 25 (i.e., a part of the vehicle body) in a manner such that it is movable away from the vehicle body. The amount of movement of the pillar garnish 27 is determined so that the airbag 20 can be deployed. In such attachment via the attachment member 34 to the pillar inner panel 25, the clip 40 passes through the attachment hole 35 of the attachment member 34 in a manner such that the second shaft part 52 of the clip 40 is slidable along the axis of the shaft.

In the above-described first embodiment, when specific conditions for airbag deployment are satisfied, an inflator (not shown) is driven so that the airbag 20 breaks the cover 31 and expands along the window 13a of the front door 13 and the window 15a of the rear door 15. In this process, the pillar garnish 27, which is pushed by the expanding airbag 20, moves toward the inside of the interior (see alternate long and two short dashed lines in FIG. 2) while pulling the spring 41 and making the clip 40 (which is attached integrally to the pillar garnish 27) slide through the attachment hole 35 of the attachment member 34. However, the clip 40 fastened to the pillar garnish 27 is also coupled via the spring 41 with the attachment member 34 which belongs to the vehicle body; thus, the spring 41 forces the pillar garnish 27 to return toward the pillar inner panel 25 (along the contraction direction of the spring 41) while the clip 40 slides through the attachment hole 35 of the attachment member 34.

In accordance with the first embodiment, when the airbag 20, which is stored between the pillar inner panel 25 as a part of the vehicle body and the pillar garnish 27 arranged on a side (toward the interior of the vehicle) of the pillar inner panel 25, is deployed toward the interior of the vehicle, the pillar garnish 27 is moved by the clip 40 towards a position distant from the pillar inner panel 25, so that the airbag 20 can be expanded. After the airbag 20 is deployed, the pillar garnish 27 is forced by the spring 41 toward the pillar inner panel 25 so that the pillar garnish 27 returns toward the pillar inner panel 25. That is, after the airbag 20 is deployed, the pillar garnish 27 approaches the pillar inner panel 25; thus, the pillar garnish 27 restores the impact absorbing ability which it obtains originally.

In addition, the pillar garnish 27 is coupled via the spring 41 to the attachment member 34 which is fastened to the pillar inner panel 25; thus, the spring 41 prevents the pillar garnish 27 from being detached. Furthermore, the coil-formed spring 41 is arranged uniformly around the clip 40; thus, the axial direction in which the clip 40 moves can be guided by the spring 41.

Instead of the spring 41, another elastic member (made of rubber or the like) may be used, which can force a target object in the contraction direction thereof. In addition, the spring 41 may be separated from the clip 40.

In addition, when the pillar garnish 27 returns toward the pillar inner panel 25 (after it moves away from the pillar inner panel 25), the second shaft part 52 of the clip 40 (which is fastened to the pillar garnish 27 via the head part 50 of the clip 40) slides axially along the attachment hole 35 formed in the attachment member 34 which is provided at the pillar inner panel 25. Therefore, it is possible to prevent the pillar garnish 27 from moving in a direction other than the predetermined direction.

FIG. 3 shows a variation of the clip 40, which has: (i) the head part 50 which has a relatively large diameter and is fit into the fittable groove 48 of the protruding stand part 46 so as to attach the clip 40 to the pillar garnish 27, and (ii) a straight shaft part 53 which has a smaller diameter than that of the head part 50 and extends from the head part 50 through the attachment hole 47 of the protruding stand part 46 toward the outside of the interior along the axial direction. In this case, the clip 40 is inserted in a manner such that the shaft part 53 is slidable through the attachment hole 35 of the attachment member 34.

With respect to the pillar garnish 27 in FIG. 2, in order for the end plate part 44 to be relatively weakly forced by the spring 41 while the side opposite to the end plate part 44 is relatively strongly forced, (i) a gap may be provided between the second shaft part 52 and the attachment hole 35 so that the pillar garnish 27 can be moved rotationally, and (ii) a plurality of springs may be non-uniformly provided around the clip 40. Accordingly, the side including the end plate part 44 can be more easily opened in comparison with the opposite side.

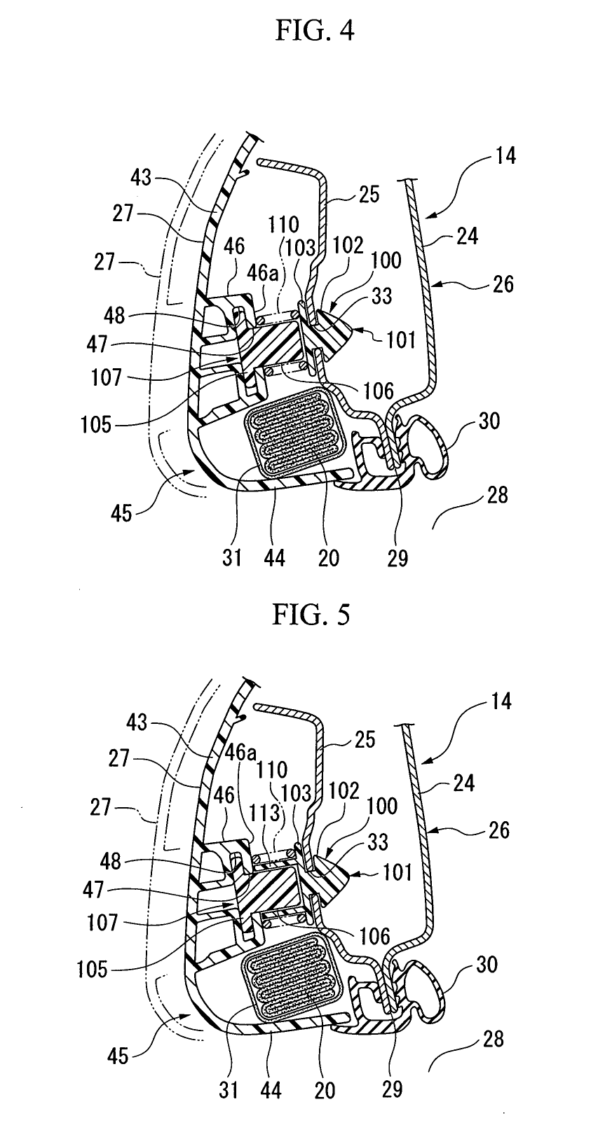

A second embodiment in accordance with the present invention will be explained with reference to FIGS. 4 to 6. In the following explanation, distinctive features in comparison with the first embodiment are described mainly. In FIGS. 4 to 6, parts identical or similar to those in the first embodiment are given identical reference numerals, and explanations thereof are omitted.

The second embodiment employs a clip 100 (i.e., an attachment device) for attaching the pillar garnish 27 to the vehicle body. The clip 100 has an end part 101 made of synthetic resin, which is attached to the through-hole 33 of the pillar inner panel 25. The end part 101 has a fittable part 102 and a flange portion 103, which are respectively provided on the outer side (toward the outside of the vehicle) and the inner side (toward the interior of the vehicle) thereof. The fittable part 102 has a tapered shape and is fit into the through-hole 33 of the pillar inner panel 25. When the fittable part 102 is fit into the through-hole 33, the pillar inner panel 25 is supported between the fittable part 102 and flange portion 103.

The clip 100 also has a clip main body 107 which includes: (i) a head part 105 which has a relatively large diameter and is fit into the fittable groove 48 of the protruding stand part 46 so as to attach the clip main body 107 to the pillar garnish 27, and (ii) a shaft part 106 which has a smaller diameter than that of the head part 105 and extends from the head part 105 through the attachment hole 47 of the protruding stand part 46 toward the outside of the interior. Although it is not shown, the fittable groove 48 is open toward a side thereof, so that the head part 105 of the clip 100 can be slid and fit into the groove 48 in a direction perpendicular to the axis of the shaft.

Accordingly, the clip 100 consists of separate bodies, that is, the clip main body 107 and the end part 101, and a spring 110 (i.e., an elastic body) is attached to the clip 100. The shaft part 106 of the clip main body 107 passes through the spring 110. In this state, an end of the spring 110 is coupled to the protruding stand part 46 of the pillar garnish 27, and the other end thereof is coupled to the flange portion 103 of the end part 101, so that the pillar garnish 27 and the end part 101 which is fastened to the vehicle body are coupled with each other. Accordingly, the spring 110 forces the pillar garnish 27 toward the pillar inner panel 25 so that an end face of the shaft part 106 in the clip 100 contacts the end part 101. The spring 110 is uniformly arranged around the shaft part 106 of the clip main body 107 in a manner such that a small gap is provided between the spring 110 and the shaft part 106.

The pillar garnish 27, to which the clip 100 and the spring 110 are attached in advance, is attached to the pillar inner panel 25 by fitting the end part 101 of the clip 100 into the through-hole 33 while the folded airbag 20 is contained between the protruding stand part 46 and the end plate part 44. Owing to the clip 100 fastened to the pillar inner panel 25 (which belongs to the vehicle body) as described above, the pillar garnish 27 is attached in a manner such that it is movable to a position distant from the pillar inner panel 25 by a predetermined distance so as to deploy the airbag 20.

Also in the above-described second embodiment, when specific conditions for airbag deployment are satisfied, an inflator (not shown) is driven so that the airbag 20 breaks the cover 31 and expands along the window 13a of the front door 13 and the window 15a of the rear door 15. In this process, the pillar garnish 27, which is pushed by the expanding airbag 20, moves toward the inside of the interior (see alternate long and two short dashed lines in FIG. 4) while pulling the spring 110 and making the clip main body 107 (which is attached integrally to the pillar garnish 27 and includes the head part 105) distant from the end part 101. However, the pillar garnish 27 is coupled via the spring 110 with the end part 101 (attached to the vehicle body) of the clip 100; thus, it returns to the pillar inner panel 25 via the spring 110 which forces the pillar garnish 27 in the contraction direction thereof.

In accordance with the second embodiment, when the airbag 20, which is stored between the pillar inner panel 25 as a part of the vehicle body and the pillar garnish 27 arranged on a side (toward the interior of the vehicle) of the pillar inner panel 25, is deployed toward the interior of the vehicle, the pillar garnish 27 is moved towards a position distant from the pillar inner panel 25, so that the airbag 20 can be expanded. After the airbag 20 is deployed, the pillar garnish 27 is forced by the spring 110 toward the pillar inner panel 25 so that the pillar garnish 27 returns toward the pillar inner panel 25. That is, after the airbag 20 is deployed, the pillar garnish 27 approaches the pillar inner panel 25; thus, the pillar garnish 27 restores the impact absorbing ability which it obtains originally.

In addition, the pillar garnish 27 is coupled via the spring 110 to the end part 101 which is fastened to the pillar inner panel 25; thus, the spring 110 prevents the pillar garnish 27 from being detached. Furthermore, the coil-formed spring 110 is arranged uniformly around the clip main body 107; thus, the axial direction in which the clip main body 107 moves can be guided by the spring 110.

Instead of the spring 110, another elastic member (made of rubber or the like) may be used, which can force a target object in the contraction direction thereof. In addition, the spring 110 may be separated from the clip 100.

In addition, the clip 100 has the shaft part 106 extending from the head part 105 (which is attached to the pillar garnish 27) toward the end part 101 which is separably coupled to the pillar garnish 27 via the spring 110. Therefore, the end part 101 can be pushed by the shaft part 106 so that the end part 101 is attached to the pillar inner panel 25. Therefore, it is possible to easily attach the clip 100 to the pillar inner panel 25, wherein the clip 100 is attached to the pillar garnish 27 in advance.

FIG. 5 shows a variation of the clip 100 of the second embodiment. In FIG. 5, the head part 101 has a cylindrical part 113, into which the shaft part 106 of the clip main body 107 is fit in a freely slidable manner. In this case, the spring 110 is arranged so that the cylindrical part 113 passes through the spring 110, and the spring 110 is coupled with the protruding stand part 46 of the pillar garnish 27 and the flange portion 103 of the end part 101. Accordingly, when the shaft part 106 slides, it is possible to prevent the shaft part 106 from interfering with the spring 110, and it is also possible to prevent the shaft part 106, that is, the pillar garnish 27, from moving in a direction other than the predetermined sliding direction.

Instead of the cylindrical part 113, a plurality of leg parts, arranged at specific intervals on a circumference, may be provided to the end part 101, so that the leg parts hold the shaft part 106 of the clip main body 107 in a freely slidable manner. Also in this case, when the shaft part 106 slides, it is possible to prevent the shaft part 106 from interfering with the spring 110, and it is also possible to prevent the shaft part 106, that is, the pillar garnish 27, from moving in a direction other than the predetermined sliding direction.

In addition, the shaft part 106 may be extended from the flange portion 103 of the end part 101 (which also has the fittable part 102) in the clip 100. That is, the clip 100 should have the shaft part 106 extending from one of the head part 105 and the end part 101.

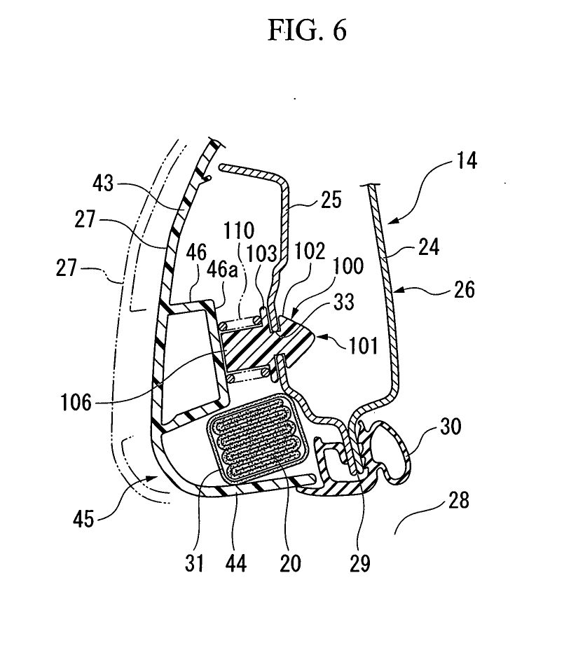

FIG. 6 shows an example in which the shaft part 106 is provided at the end part 101. As shown in FIG. 6, the head part 105 may be omitted, and in this case, the top face 46a of the protruding stand part 46 can be flat. In this structure, the flange portion 103 of the clip 100 and the pillar garnish 27 are coupled with each other via the spring 110 through which the shaft part 106 passes. The clip 100 and the spring 110 can be attached to the pillar garnish 27 in advance; thus, the spring 110 can be easily attached, similar to the other embodiments or variations.

In addition, the spring may be non-uniformly provided around the clip 100, so that the side including the end plate part 44 in the pillar garnish 27 can be more easily opened in comparison with the opposite side.

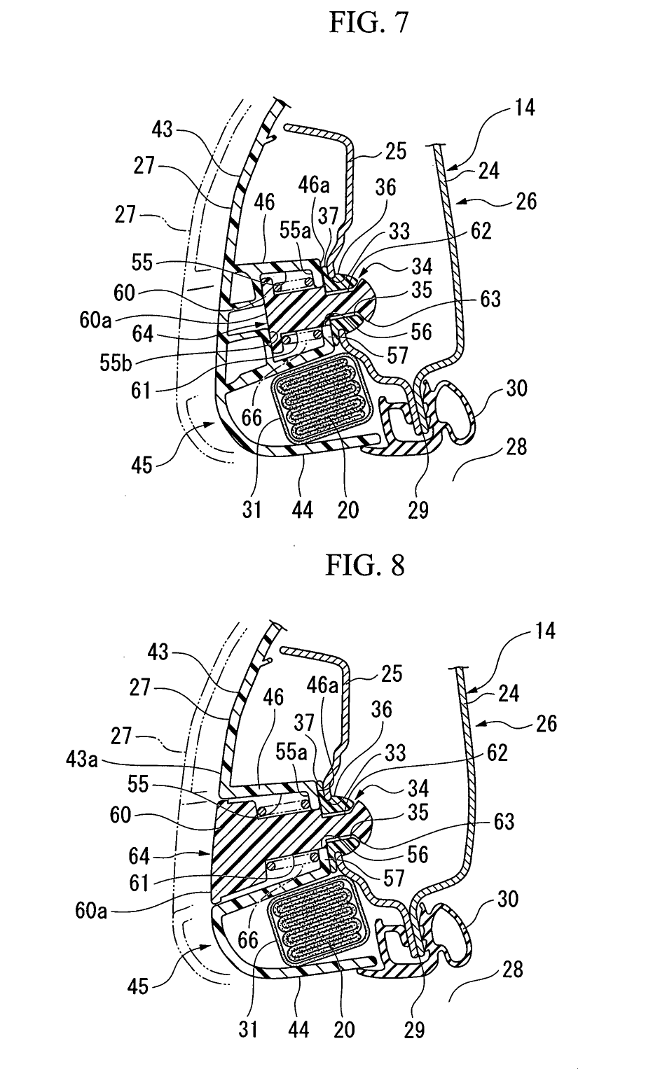

A third embodiment of the structure for protecting a passenger, in accordance with the present invention, will be explained with reference to FIG. 7. In the following explanation, distinctive features in comparison with the first embodiment are described mainly. In FIG. 7, parts identical or similar to those in the first embodiment are given identical reference numerals, and explanations thereof are omitted.

In the third embodiment, instead of the fittable groove 48 in the first embodiment, a recessed part 55 is formed in the protruding stand part 46 of the pillar garnish 27, where the recessed part 55 is larger than the fittable groove 48. The recessed part 55 has an opening 56, and an inner flange portion 57 is provided at the opening 56. The inner flange portion 57 protrudes inward in the radial directions.

The third embodiment employs a clip 64 made of synthetic resin. The clip 64 has: (i) a head part 60 which has a relatively large diameter and is fit into the recessed part 55 of the protruding stand part 46 in the pillar garnish 27, (ii) a first shaft part 61 which has a smaller diameter than that of the head part 60 and extends from the head part 60 through the opening 56 of the recessed part 55 in the protruding stand part 46 toward the outside of the interior along the axial direction of the clip 64, (iii) a second shaft part 62 which has a smaller diameter than that of the first shaft part 61 and extends from the first shaft part 61 toward a side opposite to the head part 60, and (iv) a fittable part 63 which has a larger diameter than that of the second shaft part 62 and is formed at an end (opposite to the first shaft part 61) of the second shaft part 62. Although it is not shown, the recessed part 55 is open toward a side thereof, so that the clip 64 can be slid and fit into the recessed part 55 in a direction perpendicular to the axis of the clip 64.

The clip 64 is attached to the attachment member 34 (i.e., the vehicle body) by fitting the fittable part 63 into the attachment hole 35 of the attachment member 34, and interposing the attachment member 34 by an end face of the first shaft part 61 and the fittable part 63, wherein the second shaft part 62 is fit in the attachment hole 35. The recessed part 55 in the pillar garnish 27 is guided by the head part 60 so that the pillar garnish 27 can slide by a predetermined distance in the axial direction of the head part 60.

The third embodiment also employs a spring 66 (i.e., a forcing device or an elastic body) having a coil form, through which the first shaft part 61 of the clip 64 passes. The spring 66 is arranged in the recessed part 55, and is provided between the head part 60 and the inner flange portion 57 of the pillar garnish 27. An end of the spring 66 contacts the head part 60 of the clip 64 which is fastened to the pillar inner panel 25, and the other end thereof contacts a bottom face 55a of the inner flange portion 57 in the pillar garnish 27, wherein the bottom face 55a faces a face (toward the outside of the interior) of the inner flange portion 57. The spring 66 forces or pushes the pillar garnish 27 in the expanding direction of the spring 66 towards the pillar inner panel 25 so that an inner face 55b of the recessed part 55 contacts an end face 60a of the head part 60 in the clip 64.

The pillar garnish 27, to which the clip 64, the spring 66, and the attachment member 34 are attached in advance, is attached to the pillar inner panel 25 by fitting the attachment member 34 into the through-hole 33 while the folded airbag 20 is contained between the protruding stand part 46 and the end plate part 44. Owing to the clip 64 being fastened to the pillar inner panel 25 (which belongs to the vehicle body) as described above, the pillar garnish 27 is attached in a manner such that it is movable to a position distant from the pillar inner panel 25 by a predetermined distance, so as to deploy the airbag 20.

Also in the above-described third embodiment, when specific conditions for airbag deployment are satisfied, an inflator (not shown) is driven so that the airbag 20 expands along the window 13a of the front door 13 and the window 15a of the rear door 15. In this process, the pillar garnish 27, which is pushed by the expanding airbag 20, moves toward the inside of the interior while compressing the spring 66 and sliding the recessed part 55 along the head part 60 of the clip 64, which is fastened to the pillar inner panel 25. However, the spring 66 is provided between the head part 60 of the clip 64 (fastened to the pillar inner panel 25) and the inner flange portion 57 of the pillar garnish 27; thus, the pillar garnish 27 returns to the pillar inner panel 25 via the spring 66 which forces the recessed part 55 to slide along the head part 60 of the clip 64 (i.e., in the expanding direction of the spring 66).

In accordance with the third embodiment, when the airbag 20, which is stored between the pillar inner panel 25 as a part of the vehicle body and the pillar garnish 27 arranged on a side (toward the interior of the vehicle) of the pillar inner panel 25, is deployed toward the interior of the vehicle, the pillar garnish 27 is moved by the clip 64 towards a position distant from the pillar inner panel 25, so that the airbag 20 can be expanded. After the airbag 20 is deployed, the pillar garnish 27 is forced by the spring 66 toward the pillar inner panel 25 so that the pillar garnish 27 returns toward the pillar inner panel 25. That is, after the airbag 20 is deployed, the pillar garnish 27 approaches the pillar inner panel 25; thus, the pillar garnish 27 restores the impact absorbing ability which it obtains originally.

Additionally, in the clip 64, the head part 60 is fit into the recessed part 55 formed in the pillar garnish 27, and the pillar garnish 27 can slide by a predetermined distance along the axial direction of the head part 60, which guides the recessed part 55. Therefore, the clip 64 can guide the movement of the pillar garnish 27. In addition, the spring 66 is provided between the pillar garnish 27 and the clip 64; thus, it is unnecessary to move the clip 64 with respect to the pillar inner panel 25 which belongs to the vehicle body. Accordingly, sliding of the pillar garnish 27 can be guided using the pillar garnish 27 itself and the clip 64, which have a relatively high degree of freedom of movement.

Instead of the spring 66, another elastic member (made of rubber or the like) which has an anti-compressive force may be used. In addition, the spring 66 may be separated from the clip 64.

In addition, a gap may be provided between the head part 60 and the recessed part 55 so that the pillar garnish 27 can rotate, and the spring may be non-uniformly provided around the clip 64, so that the side including the end plate part 44 in the pillar garnish 27 can be more easily opened in comparison with the opposite side.

A fourth embodiment of the structure for protecting a passenger, in accordance with the present invention, will be explained with reference to FIG. 8. In the following explanation, distinctive features in comparison with the third embodiment are described mainly. In FIG. 8, parts identical or similar to those in the third embodiment are given identical reference numerals, and explanations thereof are omitted.

In the fourth embodiment, the protruding stand part 46 has the recessed part 55, which has the inner flange portion 57 at the opening 56 and is open through the main plate part 43.

Additionally, also in the fourth embodiment, the clip 64 is fastened to the attachment member 34 by fitting the second shaft part 62 into the attachment hole 35, and interposing the attachment member 34 between the first shaft part 61 and the fittable part 63. In this state, the end face 60a of the head part 60 is coplanar with a face 43a (toward the interior of the vehicle) of the main plate part 43. In the above-described third embodiment, the recessed part 55 is open toward a side thereof, so that the clip 64 can be slid and fit into the recessed part 55 in a direction perpendicular to the axis of the clip 64. In contrast, in the fourth embodiment, the clip 64 is fit into the recessed part 55 from the side where the main plate part 43 is provided; thus, no side opening is necessary in the recessed part 55.

Similar to the third embodiment, the fourth embodiment employs the spring 66 provided between the head part 60 and the inner flange portion 57 of the pillar garnish 27, so as to force the pillar garnish 27 toward the pillar inner panel 25.

Also in the above-described fourth embodiment, when specific conditions for airbag deployment are satisfied, an inflator (not shown) is driven so that the airbag 20 expands along the window 13a of the front door 13 and the window 15a of the rear door 15. In this process, the pillar garnish 27, which is pushed by the expanding airbag 20, moves toward the inside of the interior while compressing the spring 66 and sliding the recessed part 55 along the head part 60 of the clip 64. However, the spring 66 is provided between the head part 60 of the clip 64 (fastened to the pillar inner panel 25) and the inner flange portion 57 of the pillar garnish 27. Therefore, while the spring 66 is returning to its original position, it forces the pillar garnish 27 to return to the pillar inner panel 25, wherein the recessed part 55 is slid along the head part 60 of the clip 64.

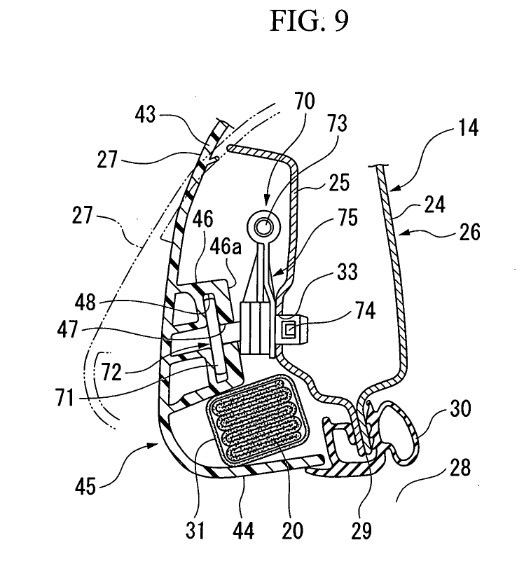

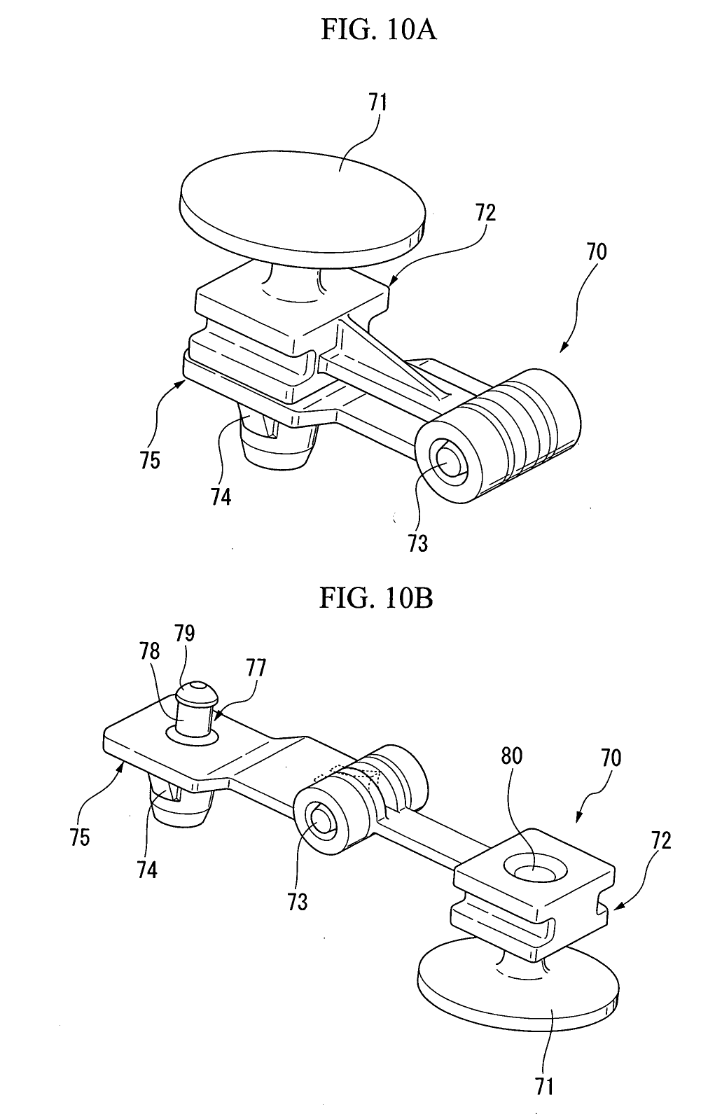

A fifth embodiment of the structure for protecting a passenger, in accordance with the present invention, will be explained with reference to FIGS. 9, 10A, and 10B. In the following explanation, distinctive features in comparison with the first embodiment are described mainly. In FIGS. 9, 10A, and 10B, parts identical or similar to those in the first embodiment are given identical reference numerals, and explanations thereof are omitted.

As shown in FIG. 9, in the fifth embodiment, a clip 70 (i.e., a forcing device or an elastic body) is provided which is coupled with the pillar garnish 27 and the pillar inner panel 25, so as to force the pillar garnish 27 toward the pillar inner panel 25.

FIG. 10A shows the clip 70 in its closed state, and FIG. 10B shows the clip 70 in its open state. As shown in FIGS. 10A and 10B, the clip 70 has a rotation member 72 made of synthetic resin, wherein an attachment fittable part 71 is formed on an end thereof. The clip 70 also has a base member 75 (i.e., a base part) made of synthetic resin, which is rotatably coupled with the other end (opposite to the attachment fittable part 71) of the rotation member 72 via a rotating shaft 73 made of metal. The base member 75 has an attachment fittable part 74 on the side opposite to the rotating shaft 73. The rotation member 72 and the base member 75 are forced to approach each other via a torsional spring (i.e., an elastic part, not shown).

When the rotation member 72 and the base member 75 contact each other, the attachment fittable part 71 and the attachment fittable part 74 face to the directions opposite to each other.

In addition, on an end (opposite to the rotating shaft 73) of the base member 75, a fittable shaft 77 is formed, which protrudes to the opposite side of the attachment member 74. The fittable shaft 77 has a shaft part 78 on its base side, and a fittable part 79 on its head side, where the fittable part 79 has a relatively large diameter in comparison with the shaft part 78.

On the other hand, in the rotation member 72, a fittable hole 80 is formed on the opposite side of the rotating shaft 73, and also on the opposite side of the attachment fittable part 71. The above fittable shaft 77 can be inserted into or pulled out from the fittable hole 80. The fittable hole 80 prevents the inserted fittable shaft 77 from being easily detached. That is, the inserted fittable shaft 77 can be detached from the fittable hole 80 only when a force of a predetermined level or greater is applied.

An end of the clip 70 is fastened to the pillar garnish 27 by inserting the fittable shaft 77 into the fittable hole 80 so that the base member 75 and the rotation member 72 contact each other, and then fitting the attachment fittable part 71 into the fittable groove 48. The other end of the clip 70 is fastened to the pillar inner panel 25 by fitting the attachment fittable part 74 into the through-hole 33 of the pillar inner panel 25. In this state, the rotating shaft 73 is positioned on the opposite side of the front door opening 28 with respect to the clip 70.

Also in the above-described fifth embodiment, when specific conditions for airbag deployment are satisfied, an inflator (not shown) is driven so that the airbag 20 expands along the window 13a of the front door 13 and the window 15a of the rear door 15. In this process, the pillar garnish 27, which is pushed by the expanding airbag 20, moves toward the inside of the interior while opposing the force of the torsional spring and thus rotating the rotation member 72 around the rotating shaft 73 with respect to the base member 75 (in this process, the fittable shaft 79 is pulled out from the fittable hole 80). However, in the clip 70 fastened to the pillar inner panel 25, the rotation member 72 and the base member 75 are forced toward each other via the torsional spring; thus, the pillar garnish 27 returns to the pillar inner panel 25 via the torsional spring having a force for returning to the original position of the pillar garnish 27.

In accordance with the fifth embodiment, when the airbag 20, which is stored between the pillar inner panel 25 as a part of the vehicle body and the pillar garnish 27 arranged on a side (toward the interior of the vehicle) of the pillar inner panel 25, is deployed toward the interior of the vehicle, the pillar garnish 27 is moved towards a position distant from the pillar inner panel 25, so that the airbag 20 can be expanded. After the airbag 20 is deployed, the pillar garnish 27 is forced toward the pillar inner panel 25 by the torsional spring provided to the clip 70 so that the pillar garnish 27 returns toward the pillar inner panel 25. That is, similar to the first to fourth embodiments, after the airbag 20 is deployed, the pillar garnish 27 approaches the pillar inner panel 25; thus, the pillar garnish 27 restores the impact absorbing ability which it obtains originally.

In addition, the clip 70 has the rotation member 72 fastened to the pillar garnish 27, the base member 75 fastened to the pillar inner panel 25, and the torsional spring for rotatably coupling these members via the rotating shaft 73 and for forcing these members to approach each other. Therefore, the clip 70 has a function of forcing the pillar garnish 27 toward the pillar inner panel 25, and also a function of attaching the pillar garnish 27 to the pillar inner panel 25, that is, both functions can be implemented by the single clip 70.

Furthermore, the clip 70 has the fittable shaft 79 and the fittable hole 80 which are released from each other when a force having a predetermined level or greater is applied. Therefore, it is possible to prevent the pillar garnish 27 from unnecessarily moving by a relatively small force.

In a variation of the present embodiment, the base member 75 itself of the clip 70 may be formed integrally in the pillar inner panel 25. That is, it is possible to provide the rotating shaft 73 at the pillar inner panel 25, and to rotatably couple the rotation member 72 to this rotating shaft 73. In addition, the whole body of the base member 75 may be fastened to the vehicle body. Furthermore, the rotation member 72 itself of the clip 70 may be formed integrally in the pillar garnish 27. That is, it is possible to provide the rotating shaft 73 at the pillar garnish 27, and to rotatably couple the base member 75 to this rotating shaft 73.

In the fifth embodiment, the clip 70 rotates around the rotating shaft 73 which is distant from the position where the clip 70 is attached to the pillar inner panel 25. Similarly, in the other embodiments, the sliding operation of the pillar garnish 27 may be executed at a position (e.g., corresponding to the rotating shaft 73 in FIG. 9) which is distant from the position where the clip is attached to the pillar inner panel 25.

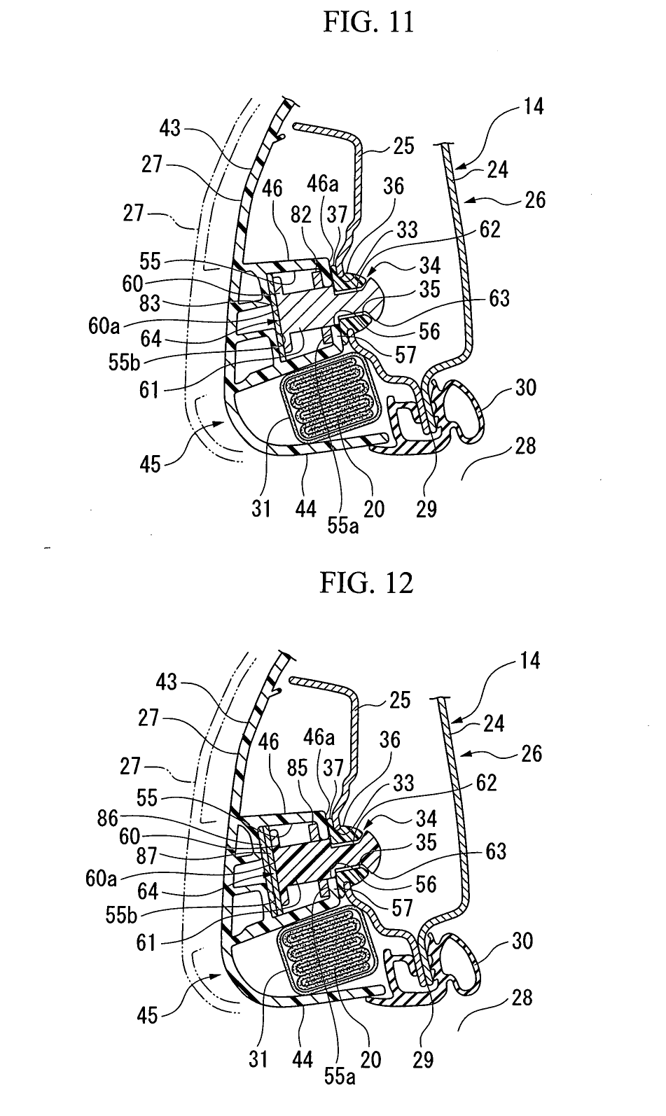

A sixth embodiment of the structure for protecting a passenger, in accordance with the present invention, will be explained with reference to FIG. 11. In the following explanation, distinctive features in comparison with the third embodiment are described mainly. In FIG. 11, parts identical or similar to those in the third embodiment are given identical reference numerals, and explanations thereof are omitted.

Similar to the third embodiment, the sixth embodiment employs a clip 64 having: (i) a head part 60 fit into the recessed part 55 which has the inner flange portion 57 at the opening 56, so as to support the recessed part 55 in a slidable manner, (ii) a first shaft part 61 extending from the head part 60, (iii) a second shaft part 62 extending from the first shaft part 61, and (iv) a fittable part 63 formed at the head of the second shaft part 62. The clip 64 is fastened to the attachment member 34, that is, the vehicle body, by fitting the second shaft part 62 into the attachment hole 35, and interposing the attachment member 34 between the first shaft part 61 and the fittable part 63. In the sixth embodiment, the clip 64 is made of metal.

In the sixth embodiment, a highly-repulsive member 82 (i.e., a returning device or a highly-repulsive part), which is made of metal and has a circular shape, is attached to the bottom face 55a (i.e., closer to the vehicle body) of the recessed part 55, wherein the bottom face 55a is formed in the inner flange portion 57. In addition, a cushioning member 83 (i.e., a cushioning device) made of rubber is joined to the inner face 55b of the recessed part 55, which faces the bottom face 55a and is closer to the interior of the vehicle in comparison with the bottom face 55a.

Also in the above-described sixth embodiment, when specific conditions for airbag deployment are satisfied, an inflator (not shown) is driven so that the airbag 20 expands along the window 13a of the front door 13 and the window 15a of the rear door 15. In this process, the pillar garnish 27, which is pushed by the expanding airbag 20, moves toward the inside of the interior while sliding the recessed part 55 along the head part 60 of the clip 64, which contacted the cushioning member 83 before the sliding operation of the recessed part 55. After the head part 60 contacts the highly-repulsive member 82 made of metal, a repulsive force of the highly-repulsive member 82 forces the pillar garnish 27 to return to the pillar inner panel 25 while sliding the recessed part 55 along the head part 60 of the clip 64. When the pillar garnish 27 returns, the head part 60 contacts the cushioning member 83 and the pillar garnish 27 stops. That is, the highly-repulsive member 82 returns the pillar garnish 27 toward the vehicle body.

In accordance with the sixth embodiment, when the airbag 20, which is stored between the pillar inner panel 25 as a part of the vehicle body and the pillar garnish 27 arranged on a side (toward the interior of the vehicle) of the pillar inner panel 25, is deployed toward the interior of the vehicle, the pillar garnish 27 is moved by the clip 64 towards a position distant from the pillar inner panel 25, so that the airbag 20 can be expanded. After the airbag 20 is deployed, the pillar garnish 27 is forced by the repulsive force of the highly-repulsive member 82 toward the pillar inner panel 25 so that the pillar garnish 27 returns toward the pillar inner panel 25. That is, after the airbag 20 is deployed, the pillar garnish 27 approaches the pillar inner panel 25; thus, the pillar garnish 27 restores the impact absorbing ability which it obtains originally.

In addition, in the present embodiment, the highly-repulsive member 82 is simply provided on the bottom face 55a of the recessed part 55 so that the pillar garnish 27 can return toward the pillar inner panel 25 by using the force due to the movement of the pillar garnish 27 to the distant position. Therefore, the structure for protecting a passenger can be implemented using a very simple structure.

Furthermore, the cushioning member 83 is provided on the inner face 55b of the recessed part 55 in the recessed part 55, wherein the inner face 55b faces the bottom face 55a which is closer to the vehicle body. Therefore, when the pillar garnish 27 returns to the pillar inner panel 25, it is possible to prevent the pillar garnish 27 from moving toward the distant position again, and to reliably return the pillar garnish 27 toward the pillar inner panel 25.

A seventh embodiment of the structure for protecting a passenger, in accordance with the present invention, will be explained with reference to FIG. 12. In the following explanation, distinctive features in comparison with the third embodiment are described mainly. In FIG. 12, parts identical or similar to those in the third embodiment are given identical reference numerals, and explanations thereof are omitted.

Similar to the third embodiment, the seventh embodiment employs a clip 64 which is made of synthetic resin and has: (i) a head part 60 fit into the recessed part 55 which has the inner flange portion 57 at the opening 56, so as to support the recessed part 55 in a slidable manner, (ii) a first shaft part 61 extending from the head part 60, (iii) a second shaft part 62 extending from the first shaft part 61, and (iv) a fittable part 63 formed at the head of the second shaft part 62. The clip 64 is fastened to the attachment member 34, that is, the vehicle body, by fitting the second shaft part 62 into the attachment hole 35, and interposing the attachment member 34 between the first shaft part 61 and the fittable part 63.

In the seventh embodiment, a magnetic body 85 (i.e., a returning device) having a circular shape is attached to the bottom face 55a (i.e., an inner face) of the recessed part 55, wherein the bottom face 55a is formed in the inner flange portion 57 and is closer to the vehicle body. In addition, another magnetic body 86 (i.e., a returning device) is attached to the inner face 55b of the recessed part 55, wherein the bottom face 55b faces the bottom face 55a and is closer to the interior of the vehicle in comparison with the bottom face 55a. Furthermore, another magnetic body 87 (i.e., a returning device) is also attached to the end face 60a of the head part 60 in the clip 64. With respect to the magnetic body 87 of the clip 64, the magnetic body 85 on the bottom face 55a generates a repulsive force, while the magnetic body 86 on the inner face 55b generates an attractive force.

Also in the above-described seventh embodiment, when specific conditions for airbag deployment are satisfied, an inflator (not shown) is driven so that the airbag 20 expands along the window 13a of the front door 13 and the window 15a of the rear door 15. In this process, the pillar garnish 27, which is pushed by the expanding airbag 20, moves toward the inside of the interior while sliding the recessed part 55 along the head part 60 of the clip 64, wherein the magnetic body 87 is attracted by the magnetic body 86 before the sliding operation of the recessed part 55. Accordingly, the magnetic body 87 at the head part 60 of the clip 64 approaches the magnetic body 85 on the bottom face 55a of the recessed part 55 while it separates from the magnetic body 86 on the inner face 55b. Due to the repulsive force between the magnetic body 87 and the magnetic body 85, and the attractive force between the magnetic body 87 and the magnetic body 86, the pillar garnish 27 returns to the pillar inner panel 25 while sliding the recessed part 55 along the head part 60 of the clip 64, until the attracted magnetic body 87 contacts the magnetic body 86. That is, the magnetic bodies 85, 86, and 87 return the pillar garnish 27 toward the pillar inner panel 25.

In accordance with the seventh embodiment, when the airbag 20, which is stored between the pillar inner panel 25 as a part of the vehicle body and the pillar garnish 27 arranged on a side (toward the interior of the vehicle) of the pillar inner panel 25, is deployed toward the interior of the vehicle, the pillar garnish 27 is moved by the clip 64 towards a position distant from the pillar inner panel 25, so that the airbag 20 can be expanded. After the airbag 20 is deployed, the pillar garnish 27 is forced toward the pillar inner panel 25 by the repulsive force between the magnetic body 87 at the clip 64 and the magnetic body 85 at the pillar garnish 27, and the attractive force between the magnetic body 87 at the clip 64 and the magnetic body 86 at the pillar garnish 27, so that the pillar garnish 27 returns toward the pillar inner panel 25. That is, after the airbag 20 is deployed, the pillar garnish 27 approaches the pillar inner panel 25; thus, the pillar garnish 27 restores the impact absorbing ability which it obtains originally.

As described above, the pillar garnish 27 is returned toward the pillar inner panel 25 by (i) the repulsive force between the magnetic body 87 at the clip 64 and the magnetic body 85 at the pillar garnish 27 and (ii) the attractive force between the magnetic body 87 at the clip 64 and the magnetic body 86 at the pillar garnish 27. Therefore, the pillar garnish 27 can be reliably returned toward the pillar inner panel 25 using a simple structure.

In the seventh embodiment, only one of the magnetic bodies 85 and 86 may be provided to the pillar garnish 27, with respect to the magnetic body 87 provided at the clip 64. That is, the pillar garnish 27 may be returned toward the pillar inner panel 25 using at least one of the repulsive force generated by the magnetic body 85 and the attractive force generated by the magnetic body 86, with respect to the magnetic body 87 provided at the clip 64.

Additionally, in the seventh embodiment, the magnetic bodies are provided to the basic structure employed in the third embodiment; however, such magnetic bodies may be provided to the basic structure employed in the first embodiment.

In the above-described first to seventh embodiments, the part which contains the airbag 20 and opens when the airbag is deployed is the pillar garnish 27 as an interior material, which covers the pillar inner panel 25 which is a constituent of the vehicle body frame. However, such a part which contains the airbag 20 and opens when the airbag is deployed may be another interior material coupled with the vehicle body. For example, the present invention may be applied to a side airbag provided on a side of a seat, or a front airbag provided at a steering wheel or an instrument panel.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

What is claimed is:

1. A structure for protecting a passenger of a vehicle, comprising:
a vehicle body of the vehicle;
an interior material arranged on an inner side of the vehicle body, which faces an interior of the vehicle;
an airbag which is stored between the vehicle body and the interior material, and is deployed toward the interior;
an attachment device for attaching the interior material to the vehicle body in a manner such that the interior material is movable to a distant position at which the airbag is deployable; and
a forcing device, provided to the interior material, for forcing the interior material toward the vehicle body.

2. The structure in accordance with claim 1, wherein the forcing device is an elastic body coupled with the interior material and the vehicle body.

3. The structure in accordance with claim 2, wherein:
the attachment device is a clip having a head part and a shaft part extending from the head part; and
the head part is attached to the interior material; and
the shaft part passes through an attachment hole formed in the vehicle body in a manner such that the shaft part is slidable along an axial direction thereof.

4. The structure in accordance with claim 2, wherein the attachment device is a clip having:
a head part attached to the interior material;
an end part which is attached to the vehicle body and is separably coupled via the elastic body with the interior material; and
a shaft part extending from one of the head part and the end part toward the other of the head part and the end part.

5. The structure in accordance with claim 1, wherein the forcing device is an elastic body provided between the interior material and the attachment device.

6. The structure in accordance with claim 5, wherein:
the attachment device is a clip having a head part and a shaft part extending from the head part;
the shaft part is attached to the vehicle body;
the head part is fit into a recessed part formed in the interior material;
the interior material is slidable along an axial direction of the shaft part by a predetermined distance while the recessed part is guided by the head part; and
the elastic body is provided in the recessed part.

7. The structure in accordance with claim 2, wherein the elastic body is a clip having:
a rotation member attached to the interior material;
a base part attached to the vehicle body; and
an elastic part for coupling the rotation member and the base part with each other via a rotating shaft in a rotatable manner, and forcing the rotation member and the base part so that they approach each other.

8. A structure for protecting a passenger of a vehicle, comprising:
a vehicle body of the vehicle;
an interior material arranged on an inner side of the vehicle body, which faces an interior of the vehicle;
an airbag which is stored between the vehicle body and the interior material, and is deployed toward the interior;
an attachment device for attaching the interior material to the vehicle body in a manner such that the interior material is movable to a distant position at which the airbag is deployable; and
a returning device, provided to the interior material, for returning the interior material toward the vehicle body.

9. The structure in accordance with claim 8, wherein:
the attachment device is a clip having a head part and a shaft part extending from the head part;
the shaft part is attached to the vehicle body;
the head part is fit into a recessed part formed in the interior material;
the interior material is slidable along an axial direction of the shaft part by a predetermined distance while the recessed part is guided by the head part; and
the returning device is a highly-repulsive part which has a relatively highly repulsive performance and is provided on a bottom face in the recessed part, wherein the bottom face is closer to the vehicle body in comparison with other inner faces of the recessed part.

10. The structure in accordance with claim 9, wherein a cushioning device is provided on an inner face of the recessed part, which faces the bottom face.

11. The structure in accordance with claim 8, wherein:
the attachment device is a clip having a head part and a shaft part extending from the head part;
the shaft part is attached to the vehicle body;
the head part is fit into a recessed part formed in the interior material;
the interior material is slidable along an axial direction of the shaft part by a predetermined distance while the recessed part is guided by the head part; and
the returning device is a magnetic body provided on an inner face of the recessed part and another magnetic body provided at the head part.
